(19) United States
(12) Patent Application Publication
(10) Pub. No.: US 2023/0203680 A1
(43) Pub. Date: Jun. 29, 2023

(54) ANODE CATALYST MATERIAL AND WATER ELECTROLYSIS DEVICE FOR HYDROGEN EVOLUTION

(71) Applicant: Industrial Technology Research Institute, Hsinchu (TW)

(72) Inventors: Wen-Hsuan CHAO, Houlong Township (TW); Kuo-Hsin LIN, Hsinchu City (TW); Hsiao-Chun HUANG, Taoyuan City (TW); Shih-Chang CHEN, Taichung City (TW); Han-Jung LI, Taoyuan City (TW); Li-Duan TSAI, Hsinchu City (TW)

(73) Assignee: Industrial Technology Research Institute, Hsinchu (TW)

(21) Appl. No.: 17/840,200

(22) Filed: Jun. 14, 2022

(30) Foreign Application Priority Data
Dec. 29, 2021 (TW) 110149302

(51) Int. Cl. C25B 11/077; C25B 1/04

(52) U.S. Cl. CPC C25B 11/077; C25B 1/04

(57) ABSTRACT

An anode catalyst material has a chemical formula of FeₐNi_{b}M_{c}N_{d}Oₑ, wherein M is Mo, W, Sn, Si, Nb, V, Cr, Ta or a combination thereof. a+b+c+d+e=1, a>0, b>0, c>0, d≥0, and e≥0. The anode catalyst material can be used in a water electrolysis device for hydrogen evolution, which includes an anode and a cathode disposed in an alkaline aqueous solution, and the anode includes the described anode catalyst material.

### CROSS REFERENCE TO RELATED APPLICATIONS

The present application is based on, and claims priority from, Taiwan Application Serial Number 110149302, filed on Dec. 29, 2021, the disclosure of which is hereby incorporated by reference herein in its entirety.

### TECHNICAL FIELD

The technical field relates to an anode catalyst material, and in particular it relates to a water electrolysis device for hydrogen evolution utilizing the same.

### BACKGROUND

Seeking alternative sources of energy is imperative now due to energy shortages, and hydrogen energy is the best choice. Hydrogen gas serving as fuel meets the requirements of environmental protection, and electrolysis of water is the easiest way to generate hydrogen and oxygen. Although electrolyzing water to generate hydrogen has many advantages, it still has a fatal flaw of consuming a lot of energy, resulting in an overly high cost. The overly high energy consumption in the electrolysis of water is related to an overly high overpotential, and the overpotential is related to electrodes, electrolyte, and product of the electrochemical reaction. For enhancing the efficiency of electrolyzing water, the electrode is critical to lowering the activation energy and increasing the reaction interface to have a low reaction onset potential and a high current activity. The activation energy can be decreased by the catalysis of the electrode surface, which is determined by the inherent catalytic properties of the electrode material.

In the process of the alkaline water electrolysis, the reactions at the cathode and the anode are shown below:

The reaction formula at the cathode:

2H₂O+2e⁻→H₂+2OH⁻(Hydrogen evolution reaction,HER)

The reaction formula at the anode:

2OH⁻→H₂O+½O₂+2e⁻(Oxygen evolution reaction,OER)

The reaction at the anode is the rate-determining step. Although a noble metal such as Pt or IrO₂ is the most catalytic electrode material, it is very expensive. IrO₂ should be replaced with another material to lower the cost.

Accordingly, a novel non-noble metal catalyst composition with low overpotential and high current activity is called for to increase activity of the oxygen evolution reaction (OER) electrode for electrolysis to generate hydrogen. In addition, the novel catalyst composition should simultaneously achieve the catalyst activity and lower the cost.

### SUMMARY

One embodiment of the disclosure provides an anode catalyst material, having a chemical formula of FeₐNi_{b}M_{c}N_{d}Oₑ, wherein M is Mo, W, Sn, Si, Nb, V, Cr, Ta or a combination thereof, a+b+c+d+e=1, a>0, b>0, c>0, d≥0, and e≥0, (a) wherein d>0 and e>0, (a1) when M is Mo, 0.0121≤a≤0.0753, 0.0366≤b≤0.2257, 0.0544≤c≤0.2917, 0.5059≤d≤0.5925, and 0.0521≤e≤0.1537; (a2) when M is W, 0.0138≤a≤0.0887, 0.0417≤b≤0.2566, 0.0365≤c≤0.3708, 0.5035≤d≤0.5782, and 0.0403≤e≤0.0778; (a3) when M is Sn, 0.0458≤a≤0.0836, 0.1307≤b≤0.2519, 0.0440≤c≤0.1979, 0.5335≤d≤0.5853, and 0.035≤e≤0.0920; (a4) when M is Si, 0.0699≤a≤0.0951, 0.2489≤b≤0.2824, 0.0136≤c≤0.0712, 0.5820≤d≤0.5983, and 0.0106≤e≤0.0280; (a5) when M is Nb, 0.0590≤a≤0.1057, 0.2089≤b≤0.3227, 0.0052≤c≤0.1257, 0.4804≤d≤0.5454, and 0.0314≤e≤0.1046; (a6) when M is V, 0.0082≤a≤0.0809, 0.0277≤b≤0.2485, 0.0092≤c≤0.1524, 0.6150≤d≤0.6878, and 0.0367≤e≤0.1258; (a7) when M is Cr, 0.0057≤a≤0.0664, 0.0171≤b≤0.2055, 0.0210≤c≤0.1694, 0.5665≤d≤0.6904, and 0.0169≤e≤0.2117; and (a8) when M is Ta, 0.0710≤a≤0.0833, 0.2053≤b≤0.2432, 0.0319≤c≤0.0551, 0.5614≤d≤0.5757, and 0.0410≤e≤0.0881; or (b) wherein d=0, and e=0 or slightly greater than 0, (b1) when M is Mo, (b1-1) 0.0548≤a≤0.2173, 0.1367≤b≤0.6469, and 0.1358≤c≤0.7815; or (b1-2) 0.4979≤a≤0.6376, 0.2282≤b≤0.3188, and 0.0436≤c≤0.2772; (b2) when M is W, (b2-1) 0.1057≤a≤0.2350, 0.3211≤b≤0.7092, and 0.0558≤c≤0.5732; or (b2-2) 0.3295≤a≤0.6485, 0.1573≤b≤0.2966, and 0.0549≤c≤0.5132; (b3) when M is Sn, (b3-1) 0.1290≤a≤0.1832, 0.4002≤b≤0.5962, and 0.2206≤c≤0.4708; or 0.1990≤a≤0.2420, 0.6566≤b≤0.7194, and 0.0386≤c≤0.1444; or (b3-2) 0.5222≤a≤0.5647, 0.2705≤b≤0.2926, and 0.1427≤c≤0.2073; and (b4) when M is Si, (b4-1) 0.2080≤a≤0.2157, 0.6500≤b≤0.6895, and 0.0998≤c≤0.1308; or (b4-2) 0.3457≤a≤0.6348, 0.1731≤b≤0.3318, and 0.0334≤c≤0.4812.

One embodiment of the disclosure provides a water electrolysis device for hydrogen evolution, including: an anode and a cathode disposed in an alkaline aqueous solution, wherein the anode includes an anode catalyst material having a chemical formula of FeₐNi_{b}M_{c}N_{d}Oₑ, wherein M is Mo, W, Sn, Si, Nb, V, Cr, Ta or a combination thereof, a+b+c+d+e=1, a>0, b>0, c>0, d≥0, and e≥0, (a) wherein d>0 and e>0, (a1) when M is Mo, 0.0121≤a≤0.0753, 0.0366≤b≤0.2257, 0.0544≤c≤0.2917, 0.5059≤d≤0.5925, and 0.0521≤e≤0.1537; (a2) when M is W, 0.0138≤a≤0.0887, 0.0417≤b≤0.2566, 0.0365≤c≤0.3708, 0.5035≤d≤0.5782, and 0.0403≤e≤0.0778; (a3) when M is Sn, 0.0458≤a≤0.0836, 0.1307≤b≤0.2519, 0.0440≤c≤0.1979, 0.5335≤d≤0.5853, and 0.035≤e≤0.0920; (a4) when M is Si, 0.0699≤a≤0.0951, 0.2489≤b≤0.2824, 0.0136≤c≤0.0712, 0.5820≤d≤0.5983, and 0.0106≤e≤0.0280; (a5) when M is Nb, 0.0590≤a≤0.1057, 0.2089≤b≤0.3227, 0.0052≤c≤0.1257, 0.4804≤d≤0.5454, and 0.0314≤e≤0.1046; (a6) when M is V, 0.0082≤a≤0.0809, 0.0277≤b≤0.2485, 0.0092≤c≤0.1524, 0.6150≤d≤0.6878, and 0.0367≤e≤0.1258; (a7) when M is Cr, 0.0057≤a≤0.0664, 0.0171≤b≤0.2055, 0.0210≤c≤0.1694, 0.5665≤d≤0.6904, and 0.0169≤e≤0.2117; and (a8) when M is Ta, 0.0710≤a≤0.0833, 0.2053≤b≤0.2432, 0.0319≤c≤0.0551, 0.5614≤d≤0.5757, and 0.0410≤e≤0.0881; or (b) wherein d=0, and e=0 or slightly greater than 0, (b1) when M is Mo, (b1-1) 0.0548≤a≤0.2173, 0.1367≤b≤0.6469, and 0.1358≤c≤0.7815; or (b1-2) 0.4979≤a≤0.6376, 0.2282≤b≤0.3188, and 0.0436≤c≤0.2772; (b2) when M is W, (b2-1) 0.1057≤a≤0.2350, 0.3211≤b≤0.7092, and 0.0558≤c≤0.5732; or (b2-2) 0.3295≤a≤0.6485, 0.1573≤b≤0.2966, and 0.0549≤c≤0.5132; (b3) when M is Sn, (b3-1) 0.1290≤a≤0.1832, 0.4002≤b≤0.5962, and 0.2206≤c≤0.4708; or 0.1990≤a≤0.2420, 0.6566≤b≤0.7194, and 0.0386≤c≤0.1444; or (b3-2) 0.5222≤a≤0.5647, 0.2705≤b≤0.2926, and 0.1427≤c≤0.2073; and (b4) when M is Si, (b4-1) 0.2080≤a≤0.2157, 0.6500≤b≤0.6895, and 0.0998≤c≤0.1308; or (b4-2) 0.3457≤a≤0.6348, 0.1731≤b≤0.3318, and 0.0334≤c≤0.4812.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides an anode catalyst material, having a chemical formula of FeₐNi_{b}M_{c}N_{d}Oₑ, wherein M is Mo, W, Sn, Si, Nb, V, Cr, Ta or a combination thereof, a+b+c+d+e=1, a>0, b>0, c>0, d≥0, and e≥0. If M is another element such as Al, Zn, Y, or Sc, the material may have no effect of the anode catalyst material or a poor effect of the anode catalyst material. In some embodiments, (a) wherein d>0 and e>0, (a1) when M is Mo, 0.0121≤a≤0.0753, 0.0366≤b≤0.2257, 0.0544≤c≤0.2917, 0.5059≤d≤0.5925, and 0.0521≤e≤0.1537. In some embodiments, (a2) when M is W, 0.0138≤a≤0.0887, 0.0417≤b≤0.2566, 0.0365≤c≤0.3708, 0.5035≤d≤0.5782, and 0.0403≤e≤0.0778. In some embodiments, (a3) when M is Sn, 0.0458≤a≤0.0836, 0.1307≤b≤0.2519, 0.0440≤c≤0.1979, 0.5335≤d≤0.5853, and 0.035≤e≤0.0920. In some embodiments, (a4) when M is Si, 0.0699≤a≤0.0951, 0.2489≤b≤0.2824, 0.0136≤c≤0.0712, 0.5820≤d≤0.5983, and 0.0106≤e≤0.0280. In some embodiments, (a5) when M is Nb, 0.0590≤a≤0.1057, 0.2089≤b≤0.3227, 0.0052c≤0.1257, 0.4804≤d≤0.5454, and 0.0314≤e≤0.1046. In some embodiments, (a6) when M is V, 0.0082≤a≤0.0809, 0.0277≤b≤0.2485, 0.0092≤c≤0.1524, 0.6150≤d≤0.6878, and 0.0367≤e≤0.1258. In some embodiments, (a7) when M is Cr, 0.0057≤a≤0.0664, 0.0171≤b≤0.2055, 0.0210≤c≤0.1694, 0.5665≤d≤0.6904, and 0.0169≤e≤0.2117. In some embodiments, (a8) when M is Ta, 0.0710≤a≤0.0833, 0.2053≤b≤0.2432, 0.0319≤c≤0.0551, 0.5614≤d≤0.5757, and 0.0410≤e≤0.0881. If a, b, or c is too high or too low, the anode catalyst material will have an overly high onset potential or an overly low current density during electrolysis of water to generate hydrogen (and oxygen). If d or e is too high, the anode catalyst material will have an overly high onset potential or an overly low current density during electrolysis of water to generate hydrogen (and oxygen). If d or e is too low, the anode catalyst material will be close to the alloy state, and the electrocatalytic catalyst will contain an overly low amount of nitrogen and oxygen. As such, the Ni(OH)₂ layer (for easier dissociation of water) formed on the anode catalyst layer will be relatively little during electrolysis of water to generate hydrogen (and oxygen), such that the onset potential is relatively high or the current density is relatively low.

In some embodiments, the anode catalyst material has a chemical formula of FeₐNi_{b}M_{c}N_{d}Oₑ, wherein d=0, and e=0 or slightly greater than 0. In other words, the anode catalyst material is alloy (FeₐNi_{b}M_{c}) or alloy oxide (FeₐNi_{b}M_{c}Oₑ). In some embodiments, (b1) when M is Mo, (b1-1) 0.0548≤a≤0.2173, 0.1367≤b≤0.6469, and 0.1358≤c≤0.7815; or (b1-2) 0.4979≤a≤0.6376, 0.2282≤b≤0.3188, and 0.0436≤c≤0.2772. In some embodiments, (b2) when M is W, (b2-1) 0.1057≤a≤0.2350, 0.3211≤b≤0.7092, and 0.0558≤c≤0.5732; or (b2-2) 0.3295≤a≤0.6485, 0.1573≤b≤0.2966, and 0.0549≤c≤0.5132. In some embodiments, (b3) when M is Sn, (b3-1) 0.1290≤a≤0.1832, 0.4002≤b≤0.5962, and 0.2206≤c≤0.4708; or 0.1990≤a≤0.2420, 0.6566≤b≤0.7194, and 0.0386≤c≤0.1444; or (b3-2) 0.5222≤a≤0.5647, 0.2705≤b≤0.2926, and 0.1427≤c≤0.2073. In some embodiments, (b4) when M is Si, (b4-1) 0.2080≤a≤0.2157, 0.6500≤b≤0.6895, and 0.0998≤c≤0.1308; or (b4-2) 0.3457≤a≤0.6348, 0.1731≤b≤0.3318, and 0.0334≤c≤0.4812. Similarly, if a, b, or c is too high or too low, the anode catalyst material will have an overly high onset potential or an overly low current density during electrolysis of water to generate hydrogen (and oxygen). Note that the element ratios in the anode catalyst material are determined by energy-dispersive X-ray spectroscopy (EDS). The steps of EDS are shown below. 1. The operating voltage of SEM is 15 kV (can be 20 kV if necessary), the working distance (WD) is 8.5 mm, and the EDS measuring live time is 60 to 120 seconds. 2. Before analyzing the formal sample, the copper-containing sample is used to collect spectrum and correct peak (Cu-Ka correction). 3. Perform the qualitative analysis operations to acquire x-ray signal spectrum, and define the more accurate qualitative analysis results from the measured elements. 4. Perform the semi-quantitative analysis based on the elements measurement from the qualitative analysis results.

In some embodiments, the anode catalyst material is a continuous layer or discontinuous particles loaded on a support. For example, the anode catalyst layer having a thickness of about 50 nm to 1200 nm can be formed on the support. If the thickness of the anode catalyst layer is too thin, the loading amount of the catalyst will be insufficient, the current density will be too low, and the catalyst activity will be poor. If the thickness of the anode catalyst layer is too thick, the stress of the anode catalyst layer coated on the support will be too high. As such, the adhesion between the catalyst layer and the support is not good enough. As the reaction continues, the anode catalyst will be gradually dissolved and peeled off from the electrode, such that the catalyst activity will decay more quickly. Alternatively, the anode catalyst particles having a diameter of 3 nm to 25 nm can be formed on the support. If the anode catalyst particles are too small, the catalyst effect will be degraded due to macroscopic quantum tunneling effect. If the anode catalyst particles are too large, the catalyst activity will also be degraded due to decreasing the surface area of the catalyst. Regardless the type, the anode catalyst material at the support surface has a density of about 0.05 mg/cm² to 2 mg/cm². If the density of the anode catalyst material is too low, the loading amount of the catalyst will be insufficient, the current density will be too low, and the catalyst activity will be poor. If the density of the anode catalyst material is too high, the stress of the anode catalyst layer coated on the support will be too high. As such, the adhesion between the catalyst layer and the support is not good enough, and the catalyst activity will be not enhanced or even degraded.

In some embodiment, the support includes metal, carbon material, conductive oxide, conductive nitride, or a combination thereof. For example, the metal can be titanium, titanium alloy, nickel, nickel alloy, aluminum, aluminum alloy, another suitable metal or alloy, or a combination thereof. In some embodiments, the carbon material can be graphite, carbon nanotube, carbon fiber, carbon microbead, another suitable carbon material, or a combination thereof. In some embodiments, the support includes mesh-shape, foam-shape, porous-shape, or a combination thereof.

One embodiment of the disclosure provides a water electrolysis device for hydrogen evolution, including: an anode and a cathode disposed in an alkaline aqueous solution, wherein the anode includes the anode catalyst material. The anode catalyst material and the support for loading the catalyst are described above, and the related description is not repeated here. In some embodiments, the alkaline aqueous solution can be an aqueous solution of NaOH, KOH, another suitable alkaline, or a combination thereof. In some embodiments, the alkaline aqueous solution has a pH of greater than 12 and less than or equal to 15. If the pH of the alkaline aqueous solution is too low, the conductivity of the solution will be poor. If the pH of the alkaline aqueous solution is too high, the viscosity of the solution will be too high. A potential can be applied to the anode and the cathode to electrolyze the alkaline aqueous solution, such that the cathode may generate hydrogen and the anode may generate oxygen.

It should be understood that the anode catalyst can be used in several electrolysis devices for hydrogen evolution, such as the anode of membrane electrode assembly, conventional electrolytic cell, or alkaline electrolyte electrolytic cell (containing structural characters such as the liquid electrolyte and porous separator). Accordingly, the anode catalyst in some embodiments of the disclosure may satisfy the requirement of electrolysis of alkaline aqueous solution to generate hydrogen. For OER, the catalyst has a high conductive ability and high electrochemical activity of OER.

Below, exemplary embodiments will be described in detail so as to be easily realized by a person having ordinary knowledge in the art. The inventive concept may be embodied in various forms without being limited to the exemplary embodiments set forth herein.

### EXAMPLES

### Example 1

FeNiMoNO catalyst material was deposited on glassy carbon (5 mm OD×4 mm H) by the reactive magnetron sputtering. A FeNi₃ target (commercially available from Ultimate Materials Technology Co., Ltd.) and a Mo target (commercially available from Ultimate Materials Technology Co., Ltd.) were provided, nitrogen and argon (e.g. nitrogen/(argon+nitrogen)=50%) were introduced, and the sputtering power for the Mo target was adjusted to perform the reactive sputtering, thereby obtaining the electrocatalytic catalyst layers of FeNiMoNO with different composition ratios (e.g. Mo/(Fe+Ni+Mo+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiMoNO catalyst materials were analyzed by energy-dispersive X-ray spectroscopy (EDS), and Mo/(Fe+Ni+Mo+N+O) was 5.44 at % to 29.17 at %. The OER electrochemical activities of the FeNiMoNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiMoNO films were shown in Table 1, in which Mo/(Fe+Ni+Mo+N+O) was 5.44 at % to 29.17 at % to achieve the better OER activity. The best current density (mA/cm²) at the RHE potential of 1.878 V of the catalyst was 42.99 mA/cm², and its onset potential was 1.487 V.

TABLE 1

| | Onset | Current density, J |
|---|---|---|
| | potential | (mA/cm² |
| Catalyst composition | (V) | @1.878 V) |
| Fe_{0.0121}Ni_{0.0366}Mo_{0.2917}N_{0.5059}O_{0.1537} | 1.483 | 36.53 |
| Fe_{0.0149}Ni_{0.0442}Mo_{0.2763}N_{0.5114}O_{0.1532} | 1.485 | 39.12 |
| Fe_{0.0181}Ni_{0.0558}Mo_{0.2620}N_{0.5123}O_{0.1518} | 1.487 | 42.87 |
| Fe_{0.0431}Ni_{0.1285}Mo_{0.2367}N_{0.5139}O_{0.0778} | 1.481 | 42.99 |
| Fe_{0.0460}Ni_{0.1387}Mo_{0.2205}N_{0.5265}O_{0.0683} | 1.471 | 42.78 |
| Fe_{0.0580}Ni_{0.1746}Mo_{0.1651}N_{0.5396}O_{0.0624} | 1.482 | 40.04 |
| Fe_{0.0617}Ni_{0.1878}Mo_{0.1425}N_{0.5516}O_{0.0564} | 1.511 | 36.38 |
| Fe_{0.0669}Ni_{0.2092}Mo_{0.0788}N_{0.5921}O_{0.0530} | 1.521 | 37.66 |
| Fe_{0.0753}Ni_{0.2257}Mo_{0.0544}N_{0.5925}O_{0.0521} | 1.525 | 35.83 |
| Fe_{0.250}Ni_{0.750} | 1.556 | 32.82 |

### Example 2

FeNiWNO catalyst material was deposited on glassy carbon (5 mm OD×4 mm H) by the reactive magnetron sputtering. A FeNi₃ target (commercially available from Ultimate Materials Technology Co., Ltd.) and a W target (commercially available from Ultimate Materials Technology Co., Ltd.) were provided, nitrogen and argon (e.g. nitrogen/(argon+nitrogen)=50%) were introduced, and the sputtering power for the W target was adjusted to perform the reactive sputtering, thereby obtaining the electrocatalytic catalyst layers of FeNiWNO with different composition ratios (e.g. W/(Fe+Ni+W+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiWNO catalyst materials were analyzed by EDS, and W/(Fe+Ni+W+N+O) was 3.65 at % to 37.08 at %. The OER electrochemical activities of the FeNiWNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiWNO films were shown in Table 2, in which W/(Fe+Ni+W+N+O) was 3.65 at % to 37.08 at % to achieve the better OER activity. The best current density (mA/cm²) at the RHE potential of 1.878 V of the catalyst was 42.56 mA/cm², and its onset potential was 1.482 V.

TABLE 2

| | Onset | Current density, J |
|---|---|---|
| | potential | (mA/cm² |
| Catalyst composition | (V) | @1.878 V) |
| Fe_{0.0138}Ni_{0.0417}W_{0.3708}N_{0.5035}O_{0.0702} | 1.486 | 36.14 |
| Fe_{0.0205}Ni_{0.0624}W_{0.3377}N_{0.5140}O_{0.0642} | 1.481 | 37.67 |
| Fe_{0.0285}Ni_{0.0759}W_{0.3174}N_{0.5140}O_{0.0642} | 1.482 | 42.56 |
| Fe_{0.0476}Ni_{0.1219}W_{0.1815}N_{0.5712}O_{0.0778} | 1.504 | 40.91 |
| Fe_{0.0731}Ni_{0.2039}W_{0.1067}N_{0.5714}O_{0.0449} | 1.525 | 36.5 |
| Fe_{0.0801}Ni_{0.2238}W_{0.0792}N_{0.5757}O_{0.0412} | 1.532 | 35.25 |
| Fe_{0.0887}Ni_{0.2566}W_{0.0365}N_{0.5782}O_{0.0403} | 1.547 | 35.02 |
| Fe_{0.250}Ni_{0.750} | 1.556 | 32.82 |

### Example 3

FeNiSnNO catalyst material was deposited on glassy carbon (5 mm OD×4 mm H) by the reactive magnetron sputtering. A FeNi₃ target (commercially available from Ultimate Materials Technology Co., Ltd.) and a Sn target (commercially available from Ultimate Materials Technology Co., Ltd.) were provided, nitrogen and argon (e.g. nitrogen/(argon+nitrogen)=50%) were introduced, and the sputtering power for the Sn target was adjusted to perform the reactive sputtering, thereby obtaining the electrocatalytic catalyst layers of FeNiSnNO with different composition ratios (e.g. Sn/(Fe+Ni+Sn+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiSnNO catalyst materials were analyzed by EDS, and Sn/(Fe+Ni+Sn+N+O) was 4.4 at % to 23.80 at %. The OER electrochemical activities of the FeNiSnNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiSnNO films were shown in Table 3, in which Sn/(Fe+Ni+Sn+N+O) was 4.40 at % to 19.79 at % to achieve the better OER activity. The best current density (mA/cm²) at the RHE potential of 1.878 V of the catalyst was 36.67 mA/cm², and its onset potential was 1.549 V.

TABLE 3

| | Onset | Current density, J |
|---|---|---|
| | potential | (mA/cm² |
| Catalyst composition | (V) | @1.878 V) |
| Fe_{0.0345}Ni_{0.0979}Sn_{0.2380}N_{0.5176}O_{0.1120} | 1.582 | 22.9 |
| Fe_{0.0458}Ni_{0.1307}Sn_{0.1979}N_{0.5335}O_{0.0920} | 1.557 | 33.41 |
| Fe_{0.0584}Ni_{0.1612}Sn_{0.1574}N_{0.5491}O_{0.0740} | 1.549 | 36.67 |
| Fe_{0.0662}Ni_{0.1873}Sn_{0.1265}N_{0.5605}O_{0.0590} | 1.546 | 35.83 |
| Fe_{0.0699}Ni_{0.2021}Sn_{0.1097}N_{0.5673}O_{0.0510} | 1.540 | 35.34 |
| Fe_{0.0766}Ni_{0.2340}Sn_{0.0737}N_{0.5806}O_{0.0350} | 1.549 | 34.86 |
| Fe_{0.0836}Ni_{0.2519}Sn_{0.0440}N_{0.5853}O_{0.0352} | 1.551 | 33.95 |
| Fe_{0.250}Ni_{0.750} | 1.556 | 32.82 |

### Example 4

FeNiSiNO catalyst material was deposited on glassy carbon (5 mm OD×4 mm H) by the reactive magnetron sputtering. A FeNi₃ target (commercially available from Ultimate Materials Technology Co., Ltd.) and a Si target (commercially available from Ultimate Materials Technology Co., Ltd.) were provided, nitrogen and argon (e.g. nitrogen/(argon+nitrogen)=50%) were introduced, and the sputtering power for the Si target was adjusted to perform the reactive sputtering, thereby obtaining the electrocatalytic catalyst layers of FeNiSiNO with different composition ratios (e.g. Si/(Fe+Ni+Si+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiSiNO catalyst materials were analyzed by EDS, and Si/(Fe+Ni+Si+N+O) was 1.36 at % to 12.04 at %. The OER electrochemical activities of the FeNiSiNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiSiNO films were shown in Table 4, in which Si/(Fe+Ni+Si+N+O) was 1.36 at % to 7.12 at % to achieve the better OER activity. The best current density (mA/cm²) at the RHE potential of 1.878 V of the catalyst was 36.75 mA/cm², and its onset potential was 1.545 V.

TABLE 4

| | Onset | Current density, J |
|---|---|---|
| | potential | (mA/cm² |
| Catalyst composition | (V) | @1.878 V) |
| Fe_{0.0602}Ni_{0.2047}Si_{0.1204}N_{0.5638}O_{0.0510} | 1.55 | 31.68 |
| Fe_{0.0721}Ni_{0.2344}Si_{0.0826}N_{0.5778}O_{0.0330} | 1.543 | 32.53 |
| Fe_{0.0699}Ni_{0.2489}Si_{0.0712}N_{0.5820}O_{0.0280} | 1.541 | 35.87 |
| Fe_{0.0743}Ni_{0.2672}Si_{0.0500}N_{0.5896}O_{0.0190} | 1.534 | 35.09 |
| Fe_{0.0861}Ni_{0.2755}Si_{0.0311}N_{0.5964}O_{0.0110} | 1.545 | 36.75 |
| Fe_{0.0951}Ni_{0.2824}Si_{0.0136}N_{0.5983}O_{0.0106} | 1.550 | 34.95 |
| Fe_{0.250}Ni_{0.750} | 1.556 | 32.82 |

### Example 5

FeNiNbNO catalyst material was deposited on glassy carbon (5 mm OD×4 mm H) by the reactive magnetron sputtering. A FeNi₃ target (commercially available from Ultimate Materials Technology Co., Ltd.) and a Nb target (commercially available from Ultimate Materials Technology Co., Ltd.) were provided, nitrogen and argon (e.g. nitrogen/(argon+nitrogen)=50%) were introduced, and the sputtering power for the Nb target was adjusted to perform the reactive sputtering, thereby obtaining the electrocatalytic catalyst layers of FeNiNbNO with different composition ratios (e.g. Nb/(Fe+Ni+Nb+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiNbNO catalyst materials were analyzed by EDS, and Nb/(Fe+Ni+Nb+N+O) was 0.52 at % to 21.86 at %. The OER electrochemical activities of the FeNiNbNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiNbNO films were shown in Table 5, in which Nb/(Fe+Ni+Nb+N+O) was 0.52 at % to 12.57 at % to achieve the better OER activity. The best current density (mA/cm²) at the RHE potential of 1.878 V of the catalyst was 42.55 mA/cm², and its onset potential was 1.529 V.

TABLE 5

| | Onset | Current density, J |
|---|---|---|
| | potential | (mA/cm² |
| Catalyst composition | (V) | @1.878 V) |
| Fe_{0.0318}Ni_{0.0978}Nb_{0.2186}N_{0.4875}O_{0.1642} | 1.611 | 22.25 |
| Fe_{0.0591}Ni_{0.1773}Nb_{0.1543}N_{0.4941}O_{0.1152} | 1.555 | 32.13 |
| Fe_{0.0590}Ni_{0.2089}Nb_{0.1257}N_{0.4912}O_{0.1046} | 1.561 | 38.16 |
| Fe_{0.0784}Ni_{0.2351}Nb_{0.0887}N_{0.4950}O_{0.1020} | 1.553 | 38.30 |
| Fe_{0.0816}Ni_{0.2647}Nb_{0.0784}N_{0.5033}O_{0.0720} | 1.551 | 39.76 |
| Fe_{0.1007}Ni_{0.2922}Nb_{0.0582}N_{0.4898}O_{0.0591} | 1.542 | 39.54 |
| Fe_{0.0931}Ni_{0.2793}Nb_{0.0354}N_{0.5210}O_{0.0712} | 1.532 | 38.72 |
| Fe_{0.0880}Ni_{0.2816}Nb_{0.0305}N_{0.5256}O_{0.0742} | 1.531 | 39.88 |
| Fe_{0.1027}Ni_{0.3136}Nb_{0.0330}N_{0.4804}O_{0.0703} | 1.539 | 38.59 |
| Fe_{0.0906}Ni_{0.2866}Nb_{0.0161}N_{0.5240}O_{0.0827} | 1.534 | 39.19 |
| Fe_{0.1029}Ni_{0.3311}Nb_{0.0102}N_{0.5202}O_{0.0356} | 1.529 | 39.79 |
| Fe_{0.1057}Ni_{0.3227}Nb_{0.0052}N_{0.5454}O_{0.0314} | 1.529 | 42.55 |
| Fe_{0.250}Ni_{0.750} | 1.556 | 32.82 |

### Example 6

FeNiVNO catalyst material was deposited on glassy carbon (5 mm OD×4 mm H) by the reactive magnetron sputtering. A FeNi₃ target (commercially available from Ultimate Materials Technology Co., Ltd.) and a V target (commercially available from Ultimate Materials Technology Co., Ltd.) were provided, nitrogen and argon (e.g. nitrogen/(argon+nitrogen)=50%) were introduced, and the sputtering power for the V target was adjusted to perform the reactive sputtering, thereby obtaining the electrocatalytic catalyst layers of FeNiVNO with different composition ratios (e.g. V/(Fe+Ni+V+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiVNO catalyst materials were analyzed by EDS, and V/(Fe+Ni+V+N+O) was 0.92 at % to 15.24 at %. The OER electrochemical activities of the FeNiVNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiVNO films were shown in Table 6, in which V/(Fe+Ni+V+N+O) was 0.92 at % to 15.24 at % to achieve the better OER activity. The best current density (mA/cm²) at the RHE potential of 1.878 V of the catalyst was 43.26 mA/cm² and its onset potential was 1.485 V.

TABLE 6

| | Onset | Current density, J |
|---|---|---|
| | potential | (mA/cm² |
| Catalyst composition | (V) | @1.878 V) |
| Fe_{0.0082}Ni_{0.0277}V_{0.1524}N_{0.6878}O_{0.1238} | 1.487 | 37.40 |
| Fe_{0.0134}Ni_{0.0400}V_{0.1405}N_{0.6803}O_{0.1258} | 1.485 | 43.26 |
| Fe_{0.0378}Ni_{0.1134}V_{0.1174}N_{0.6i98}O_{0.1116} | 1.517 | 42.45 |
| Fe_{0.0434}Ni_{0.1300}V_{0.0966}N_{0.6280}O_{0.1020} | 1.520 | 39.09 |
| Fe_{0.0371}Ni_{0.1186}V_{0.0778}N_{0.6497}O_{0.1167} | 1.519 | 38.79 |
| Fe_{0.0555}Ni_{0.1770}V_{0.0666}N_{0.6019}O_{0.0990} | 1.517 | 38.93 |
| Fe_{0.0755}Ni_{0.2259}V_{0.0418}N_{0.6150}O_{0.0418} | 1.529 | 39.15 |
| Fe_{0.0740}Ni_{0.2367}V_{0.0330}N_{0.6193}O_{0.0371} | 1.527 | 39.81 |
| Fe_{0.0784}Ni_{0.2353}V_{0.0288}N_{0.6208}O_{0.0367} | 1.528 | 37.53 |
| Fe_{0.0809}Ni_{0.2485}V_{0.0092}N_{0.6198}O_{0.0416} | 1.529 | 35.41 |
| Fe_{0.250}Ni_{0.750} | 1.556 | 32.82 |

### Example 7

FeNiCrNO catalyst material was deposited on glassy carbon (5 mm OD×4 mm H) by the reactive magnetron sputtering. A FeNi₃ target (commercially available from Ultimate Materials Technology Co., Ltd.) and a Cr target (commercially available from Ultimate Materials Technology Co., Ltd.) were provided, nitrogen and argon (e.g. nitrogen/(argon+nitrogen)=50%) were introduced, and the sputtering power for the Cr target was adjusted to perform the reactive sputtering, thereby obtaining the electrocatalytic catalyst layers of FeNiCrNO with different composition ratios (e.g. Cr/(Fe+Ni+Cr+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiCrNO catalyst materials were analyzed by energy-dispersive X-ray spectroscopy (EDS), and Cr/(Fe+Ni+Cr+N+O) was 2.10 at % to 16.94 at %. The OER electrochemical activities of the FeNiCrNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiCrNO films were shown in Table 7, in which Cr/(Fe+Ni+Cr+N+O) was 2.10 at % to 16.94 at % to achieve the better OER activity. The best current density (mA/cm²) at the RHE potential of 1.878 V of the catalyst was 43.87 mA/cm², and its onset potential was 1.478 V.

TABLE 7

| | Onset | Current density, J |
|---|---|---|
| | potential | (mA/cm² |
| Catalyst composition | (V) | @1.878 V) |
| Fe_{0.0057}Ni_{0.0171}Cr_{0.1694}N_{0.5961}O_{0.2117} | 1.479 | 37.01 |
| Fe_{0.0108}Ni_{0.0340}Cr_{0.1655}N_{0.5840}O_{0.2057} | 1.478 | 43.87 |
| Fe_{0.0289}Ni_{0.0916}Cr_{0.1237}N_{0.5665}O_{0.1857} | 1.527 | 38.26 |
| Fe_{0.0270}Ni_{0.0867}Cr_{0.0672}N_{0.6442}O_{0.1749} | 1.526 | 37.74 |
| Fe_{0.0524}Ni_{0.1580}Cr_{0.0607}N_{0.6445}O_{0.0844} | 1.534 | 36.01 |
| Fe_{0.0544}Ni_{0.1598}Cr_{0.0440}N_{0.6558}O_{0.0860} | 1.531 | 37.77 |
| Fe_{0.0657}Ni_{0.2003}Cr_{0.0336}N_{0.6660}O_{0.0344} | 1.529 | 36.01 |
| Fe_{0.0664}Ni_{0.2055}Cr_{0.0210}N_{0.6904}O_{0.0169} | 1.529 | 39.30 |
| Fe_{0.250}Ni_{0.750} | 1.556 | 32.82 |

### Example 8

FeNiTaNO catalyst material was deposited on glassy carbon (5 mm OD×4 mm H) by the reactive magnetron sputtering. A FeNi₃ target (commercially available from Ultimate Materials Technology Co., Ltd.) and a Ta target (commercially available from Ultimate Materials Technology Co., Ltd.) were provided, nitrogen and argon (e.g. nitrogen/(argon+nitrogen)=50%) were introduced, and the sputtering power for the Ta target was adjusted to perform the reactive sputtering, thereby obtaining the electrocatalytic catalyst layers of FeNiTaNO with different composition ratios (e.g. Ta/(Fe+Ni+Ta+N+O)) deposited on the glassy carbon. The argon and the nitrogen had a total flow rate of 20 sccm, the sputtering pressure was controlled to 20 mTorr, the process temperature was controlled to room temperature, the sputtering period was 7 minutes to 8 minutes, and the sputtered film had a thickness of about 100 nm. The compositions of the FeNiTaNO catalyst materials were analyzed by EDS, and Ta/(Fe+Ni+Ta+N+O) was 1.69 at % to 20.61 at %. The OER electrochemical activities of the FeNiTaNO catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiTaNO films were shown in Table 8, in which Ta/(Fe+Ni+Ta+N+O) was 3.19 at % to 5.51 at % to achieve the better OER activity. The best current density (mA/cm²) at the RHE potential of 1.878 V of the catalyst was 42.12 mA/cm², and its onset potential was 1.529 V.

TABLE 8

| | Onset | Current density, J |
|---|---|---|
| | potential | (mA/cm² |
| Catalyst composition | (V) | @1.878 V) |
| Fe_{0.0295}Ni_{0.0814}Ta_{0.2061}N_{0.5718}O_{0.1113} | 1.567 | 27.12 |
| Fe_{0.0422}Ni_{0.1190}Ta_{0.1230}N_{0.5795}O_{0.1364} | 1.551 | 27.38 |
| Fe_{0.0585}Ni_{0.1667}Ta_{0.1146}N_{0.5653}O_{0.0948} | 1.539 | 28.43 |
| Fe_{0.0716}Ni_{0.2048}Ta_{0.0689}N_{0.5590}O_{0.0957} | 1.546 | 28.71 |
| Fe_{0.0711}Ni_{0.2100}Ta_{0.0551}N_{0.5757}O_{0.0881} | 1.536 | 37.21 |
| Fe_{0.0710}Ni_{0.2053}Ta_{0.0410}N_{0.5614}O_{0.0410} | 1.529 | 42.12 |
| Fe_{0.0833}Ni_{0.2432}Ta_{0.0319}N_{0.5705}O_{0.0711} | 1.536 | 37.85 |
| Fe_{0.0779}Ni_{0.2258}Ta_{0.0169}N_{0.5984}O_{0.0810} | 1.545 | 31.26 |
| Fe_{0.250}Ni_{0.750} | 1.556 | 32.82 |

### Example 9

FeNiMo catalyst material was deposited on glassy carbon (5 mm OD×4 mm H) by the reactive magnetron sputtering. A FeNi₃ target (commercially available from Ultimate Materials Technology Co., Ltd.) and a Mo target (commercially available from Ultimate Materials Technology Co., Ltd.) were provided, argon was introduced, and the sputtering power for the Mo target was adjusted to perform the co-sputtering, thereby obtaining the electrocatalytic catalyst layers of FeNiMo with different composition ratios (e.g. Mo/(Fe+Ni+Mo)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiMo catalyst materials were analyzed by EDS, and Mo/(Fe+Ni+Mo) was 13.58 at % to 78.15 at %. The OER electrochemical activities of the FeNiMo catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiMo films were shown in Table 9, in which Mo/(Fe+Ni+Mo) was 13.58 at % to 78.15 at % to achieve the better OER activity. The best current density (mA/cm²) at the RHE potential of 1.878 V of the catalyst was 39.52 mA/cm², and its onset potential was 1.512 V.

TABLE 9

| | Onset | Current density, J |
|---|---|---|
| | potential | (mA/cm² |
| Catalyst composition | (V) | @1.878 V) |
| Fe_{0.0548}Ni_{0.1637}Mo_{0.7815} | 1.517 | 35.57 |
| Fe_{0.0867}Ni_{0.2266}Mo_{0.6867} | 1.512 | 37.11 |
| Fe_{0.1107}Ni_{0.2966}Mo_{0.5927} | 1.484 | 37.42 |
| Fe_{0.1596}Ni_{0.4374}Mo_{0.4003} | 1.517 | 37.41 |
| Fe_{0.1616}Ni_{0.4663}Mo_{0.3721} | 1.512 | 39.52 |
| Fe_{0.1827}Ni_{0.5330}Mo_{0.2843} | 1.530 | 36.02 |
| Fe_{0.2173}Ni_{0.6469}Mo_{0.1358} | 1.547 | 34.43 |
| Fe_{0.250}Ni_{0.750} | 1.556 | 32.82 |

### Example 10

FeNiW catalyst material was deposited on glassy carbon (5 mm OD×4 mm H) by the reactive magnetron sputtering. A FeNi₃ target (commercially available from Ultimate Materials Technology Co., Ltd.) and a W target (commercially available from Ultimate Materials Technology Co., Ltd.) were provided, argon was introduced, and the sputtering power for the W target was adjusted to perform the co-sputtering, thereby obtaining the electrocatalytic catalyst layers of FeNiW with different composition ratios (e.g. W/(Fe+Ni+W)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiW catalyst materials were analyzed by EDS, and W/(Fe+Ni+W) was 5.58 at % to 57.32 at %. The OER electrochemical activities of the FeNiW catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiW films were shown in Table 10, in which W/(Fe+Ni+W) was 5.58 at % to 57.32 at % to achieve the better OER activity. The best current density (mA/cm²) at the RHE potential of 1.878 V of the catalyst was 41.21 mA/cm² and its onset potential was 1.505 V.

TABLE 10

| | Onset | Current density, J |
|---|---|---|
| | potential | (mA/cm² |
| Catalyst composition | (V) | @1.878 V) |
| Fe_{0.1057}Ni_{0.3211}W_{0.5732} | 1.512 | 35.87 |
| Fe_{0.1441}Ni_{0.3605}W_{0.4954} | 1.509 | 38.12 |
| Fe_{0.1684}Ni_{0.4360}W_{0.3956} | 1.505 | 41.21 |
| Fe_{0.2042}Ni_{0.5463}W_{0.2560} | 1.519 | 37.22 |
| Fe_{0.2200}Ni_{0.5934}W_{0.1866} | 1.515 | 36.91 |
| Fe_{0.2167}Ni_{0.6215}W_{0.1618} | 1.519 | 33.89 |
| Fe_{0.2299}Ni_{0.6561}W_{0.1140} | 1.524 | 38.11 |
| Fe_{0.2350}Ni_{0.7092}W_{0.0558} | 1.547 | 35.46 |
| Fe_{0.250}Ni_{0.750} | 1.556 | 32.82 |

### Example 11

FeNiSn catalyst material was deposited on glassy carbon (5 mm OD×4 mm H) by the reactive magnetron sputtering. A FeNi₃ target (commercially available from Ultimate Materials Technology Co., Ltd.) and a Sn target (commercially available from Ultimate Materials Technology Co., Ltd.) were provided, argon was introduced, and the sputtering power for the Sn target was adjusted to perform the co-sputtering, thereby obtaining the electrocatalytic catalyst layers of FeNiSn with different composition ratios (e.g. Sn/(Fe+Ni+Sn)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiSn catalyst materials were analyzed by EDS, and Sn/(Fe+Ni+Sn) was 3.86 at % to 47.08 at %. The OER electrochemical activities of the FeNiSn catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiSn films were shown in Table 11, in which Sn/(Fe+Ni+Sn) was 3.86 at % to 14.44 at % or 22.06 at % to 47.08 at % to achieve the better OER activity. The best current density (mA/cm²) at the RHE potential of 1.878 V of the catalyst was 35.12 mA/cm², and its onset potential was 1.556 V.

TABLE 11

| | Onset | Current density, J |
|---|---|---|
| | potential | (mA/cm² |
| Catalyst composition | (V) | @1.878 V) |
| Fe_{0.1290}Ni_{0.4002}Sn_{0.4708} | 1.557 | 33.46 |
| Fe_{0.1647}Ni_{0.5125}Sn_{0.3228} | 1.553 | 34.68 |
| Fe_{0.1832}Ni_{0.5962}Sn_{0.2206} | 1.554 | 33.78 |
| Fe_{0.1766}Ni_{0.6220}Sn_{0.2015} | 1.557 | 32.17 |
| Fe_{0.1990}Ni_{0.6566}Sn_{0.1444} | 1.558 | 33.7 |
| Fe_{0.2039}Ni_{0.6910}Sn_{0.1051} | 1.556 | 35.12 |
| Fe_{0.2420}Ni_{0.7194}Sn_{0.0386} | 1.558 | 33.83 |
| Fe_{0.250}Ni_{0.750} | 1.556 | 32.82 |

### Example 12

FeNiSi catalyst material was deposited on glassy carbon (5 mm OD×4 mm H) by the reactive magnetron sputter. A FeNi₃ target (commercially available from Ultimate Materials Technology Co., Ltd.) and a Si target (commercially available from Ultimate Materials Technology Co., Ltd.) were provided, argon was introduced, and the sputtering power for the Si target was adjusted to perform the co-sputtering, thereby obtaining the electrocatalytic catalyst layers of FeNiSi with different composition ratios (e.g. Si/(Fe+Ni+Si)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiSi catalyst materials were analyzed by EDS, and Si/(Fe+Ni+Si) was 5.93 at % to 32.15 at %. The OER electrochemical activities of the FeNiSi catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiSi films were shown in Table 12, in which Si/(Fe+Ni+Si) was 9.98 at % to 13.08 at % to achieve the better OER activity. The best current density (mA/cm²) at the RHE potential of 1.878 V of the catalyst was 33.07 mA/cm², and its onset potential was 1.550 V.

TABLE 12

| | Onset | Current density, J |
|---|---|---|
| | potential | (mA/cm² |
| Catalyst composition | (V) | @1.878 V) |
| Fe_{0.1651}Ni_{0.5134}Si_{0.3215} | 1.554 | 31.81 |
| Fe_{0.1821}Ni_{0.5911}Si_{0.2268} | 1.567 | 30.53 |
| Fe_{0.2070}Ni_{0.6381}Si_{0.1550} | 1.552 | 32.08 |
| Fe_{0.2097}Ni_{0.6895}Si_{0.1008} | 1.550 | 33.07 |
| Fe_{0.2211}Ni_{0.6801}Si_{0.0988} | 1.570 | 29.47 |
| Fe_{0.2212}Ni_{0.7195}Si_{0.0593} | 1.575 | 26.81 |
| Fe_{0.250}Ni_{0.750} | 1.556 | 32.82 |

### Example 13

FeNiMo catalyst material was deposited on glassy carbon (5 mm OD×4 mm H) by the reactive magnetron sputtering. A Fe₂Ni target (commercially available from Ultimate Materials Technology Co., Ltd.) and a Mo target (commercially available from Ultimate Materials Technology Co., Ltd.) were provided, argon was introduced, and the sputtering power for the Mo target was adjusted to perform the co-sputtering, thereby obtaining the electrocatalytic catalyst layers of FeNiMo with different composition ratios (e.g. Mo/(Fe+Ni+Mo)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiMo catalyst materials were analyzed by EDS, and Mo/(Fe+Ni+Mo) was 4.36 at % to 45.98 at %. The OER electrochemical activities of the FeNiMo catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiMo films were shown in Table 13, in which Mo/(Fe+Ni+Mo) was 4.36 at % to 27.72 at % to achieve the better OER activity. The best current density (mA/cm²) at the RHE potential of 1.878 V of the catalyst was 36.26 mA/cm², and its onset potential was 1.530 V.

TABLE 13

| | Onset | Current density, J |
|---|---|---|
| | potential | (mA/cm² |
| Catalyst composition | (V) | @1.878 V) |
| Fe_{0.3700}Ni_{0.1702}Mo_{0.4598} | 1.615 | 19.05 |
| Fe_{0.4979}Ni_{0.2282}Mo_{0.2772} | 1.535 | 32.48 |
| Fe_{0.5559}Ni_{0.2760}Mo_{0.1681} | 1.517 | 33.55 |
| Fe_{0.5771}Ni_{0.2795}Mo_{0.1433} | 1.512 | 33.42 |
| Fe_{0.6129}Ni_{0.3119}Mo_{0.0752} | 1.530 | 36.26 |
| Fe_{0.6376}Ni_{0.3188}Mo_{0.0436} | 1.546 | 28.45 |
| Fe_{0.67}Ni_{0.33} | 1.582 | 22.42 |

### Example 14

FeNiW catalyst material was deposited on glassy carbon (5 mm OD×4 mm H) by the reactive magnetron sputter. A Fe₂Ni target (commercially available from Ultimate Materials Technology Co., Ltd.) and a W target (commercially available from Ultimate Materials Technology Co., Ltd.) were provided, argon was introduced, and the sputtering power for the W target was adjusted to perform the co-sputtering, thereby obtaining the electrocatalytic catalyst layers of FeNiW with different composition ratios (e.g. W/(Fe+Ni+W)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiW catalyst materials were analyzed by EDS, and W/(Fe+Ni+W) was 1.49 at % to 51.32 at %. The OER electrochemical activities of the FeNiW catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiW films were shown in Table 14, in which W/(Fe+Ni+W) was 5.49 at % to 51.32 at % to achieve the better OER activity. The best current density (mA/cm²) at the RHE potential of 1.878 V of the catalyst was 34.98 mA/cm², and its onset potential was 1.550 V.

TABLE 14

| | Onset | Current density, J |
|---|---|---|
| | potential | (mA/cm² |
| Catalyst composition | (V) | @1.878 V) |
| Fe_{0.3295}Ni_{0.1573}W_{0.5132} | 1.557 | 29.72 |
| Fe_{0.4303}Ni_{0.1773}W_{0.3925} | 1.550 | 34.98 |
| Fe_{0.5494}Ni_{0.2375}W_{0.2131} | 1.553 | 32.06 |
| Fe_{0.5680}Ni_{0.2443}W_{0.1977} | 1.567 | 33.37 |
| Fe_{0.5946}Ni_{0.2547}W_{0.1507} | 1.563 | 32.26 |
| Fe_{0.6336}Ni_{0.2771}W_{0.0893} | 1.583 | 30.93 |
| Fe_{0.6485}Ni_{0.2966}W_{0.0549} | 1.576 | 31.19 |
| Fe_{0.6556}Ni_{0.3295}W_{0.0149} | 1.580 | 22.02 |
| Fe_{0.67}Ni_{0.33} | 1.582 | 22.42 |

### Example 15

FeNiSn catalyst material was deposited on glassy carbon (5 mm OD×4 mm H) by the reactive magnetron sputter. A Fe₂Ni target (commercially available from Ultimate Materials Technology Co., Ltd.) and a Sn target (commercially available from Ultimate Materials Technology Co., Ltd.) were provided, argon was introduced, and the sputtering power for the Sn target was adjusted to perform the co-sputtering, thereby obtaining the electrocatalytic catalyst layers of FeNiSn with different composition ratios (e.g. Sn/(Fe+Ni+Sn)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiSn catalyst materials were analyzed by EDS, and Sn/(Fe+Ni+Sn) was 14.27 at % to 41.39 at %. The OER electrochemical activities of the FeNiSn catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiSn films were shown in Table 15, in which Sn/(Fe+Ni+Sn) was 14.27 at % to 20.73 at % to achieve the better OER activity. The best current density (mA/cm²) at the RHE potential of 1.878 V of the catalyst was 32.44 mA/cm², and its onset potential was 1.557 V.

TABLE 15

| | Onset | Current density, J |
|---|---|---|
| | potential | (mA/cm² |
| Catalyst composition | (V) | @1.878 V) |
| Fe_{0.3854}Ni_{0.2007}Sn_{0.4139} | 1.533 | 16.44 |
| Fe_{0.4728}Ni_{0.2412}Sn_{0.2860} | 1.551 | 23.06 |
| Fe_{0.5222}Ni_{0.2705}Sn_{0.2073} | 1.558 | 32.32 |
| Fe_{0.5647}Ni_{0.2926}Sn_{0.1427} | 1.557 | 32.44 |
| Fe_{0.67}Ni_{0.33} | 1.582 | 22.42 |

### Example 16

FeNiSi catalyst material was deposited on glassy carbon (5 mm OD×4 mm H) by the reactive magnetron sputter. A Fe₂Ni target (commercially available from Ultimate Materials Technology Co., Ltd.) and a Si target (commercially available from Ultimate Materials Technology Co., Ltd.) were provided, argon was introduced, and the sputtering power for the Si target was adjusted to perform the co-sputtering, thereby obtaining the electrocatalytic catalyst layers of FeNiSi with different composition ratios (e.g. Si/(Fe+Ni+Si)) deposited on the glassy carbon. The argon had a flow rate of 10 sccm, the sputtering pressure was controlled to 5 mTorr, the process temperature was controlled to room temperature, the sputtering period was 3 minutes to 4 minutes, and the sputtered film had a thickness of about 100 nm. The compositions of the FeNiSi catalyst materials were analyzed by EDS, and Si/(Fe+Ni+Si) was 1.54 at % to 48.12 at %. The OER electrochemical activities of the FeNiSi catalyst materials of different composition ratios were tested. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the FeNiSi films were shown in Table 16, in which Si/(Fe+Ni+Si) was 3.34 at % to 48.12 at % to achieve the better OER activity. The best current density (mA/cm²) at the RHE potential of 1.878 V of the catalyst was 36.4 mA/cm², and its onset potential was 1.549 V.

TABLE 16

| | Onset | Current density, J |
|---|---|---|
| | potential | (mA/cm² |
| Catalyst composition | (V) | @1.878 V) |
| Fe_{0.3457}Ni_{0.1731}Si_{0.4812} | 1.558 | 25.45 |
| Fe_{0.4331}Ni_{0.2340}Si_{0.3328} | 1.574 | 29.07 |
| Fe_{0.4998}Ni_{0.2536}Si_{0.2466} | 1.551 | 27.75 |
| Fe_{0.5349}Ni_{0.2787}Si_{0.1865} | 1.556 | 34.71 |
| Fe_{0.5801}Ni_{0.3091}Si_{0.1108} | 1.549 | 36.40 |
| Fe_{0.6129}Ni_{0.3204}Si_{0.0667} | 1.558 | 35.67 |
| Fe_{0.6161}Ni_{0.3221}Si_{0.0618} | 1.560 | 33.59 |
| Fe_{0.6348}Ni_{0.3318}Si_{0.0334} | 1.563 | 23.59 |
| Fe_{0.6571}Ni_{0.3275}Si_{0.0154} | 1.575 | 22.05 |
| Fe_{0.67}Ni_{0.33} | 1.582 | 22.42 |

### Comparative Example

Pt catalyst material was deposited on glassy carbon (5 mm OD×4 mm H) by the reactive magnetron sputter. A Pt target was provided and argon was introduced to perform the reactive sputtering, thereby depositing the Pt layer. The argon had a flow rate of 20 sccm, the sputtering pressure was controlled to 20 mTorr, the process temperature was controlled to room temperature, the sputtering period was 5 minutes to 6 minutes, and the sputtered film had a thickness of about 100 nm. The OER electrochemical activities of the Pt catalyst material and IrOx catalyst material (commercially available from TKK) were tested, respectively. In 0.1 M KOH solution, Hg/HgO served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the Pt film and IrOₓ were shown in Table 17.

TABLE 17

| | Onset | Current density, J |
|---|---|---|
| | potential | (mA/cm² |
| Catalyst composition | (V) | @1.878 V) |
| IrOₓ | 1.489 | 20.05 |
| Pt film | 1.502 | 23.20 |

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An anode catalyst material, having
a chemical formula of FeₐNi_{b}M_{c}N_{d}Oₑ, wherein M is Mo, W, Sn, Si, Nb, V, Cr, Ta or a combination thereof, a+b+c+d+e=1, a>0, b>0, c>0, d>0, and e>0,
(a) wherein d>0 and e>0,
(a1) when M is Mo, 0.0121≤a≤0.0753, 0.0366≤b≤0.2257, 0.0544≤c≤0.2917, 0.5059≤d≤0.5925, and 0.0521≤e≤0.1537;
(a2) when M is W, 0.0138≤a≤0.0887, 0.0417≤b≤0.2566, 0.0365≤c≤0.3708, 0.5035≤d≤0.5782, and 0.0403≤e≤0.0778;
(a3) when M is Sn, 0.0458≤a≤0.0836, 0.1307≤b≤0.2519, 0.0440≤c≤0.1979, 0.5335≤d≤0.5853, and 0.035≤e≤0.0920;
(a4) when M is Si, 0.0699≤a≤0.0951, 0.2489≤b≤0.2824, 0.0136≤c≤0.0712, 0.5820≤d≤0.5983, and 0.0106≤e≤0.0280;
(a5) when M is Nb, 0.0590≤a≤0.1057, 0.2089≤b≤0.3227, 0.0052≤c≤0.1257, 0.4804≤d≤0.5454, and 0.0314≤e≤0.1046;
(a6) when M is V, 0.0082≤a≤0.0809, 0.0277≤b≤0.2485, 0.0092≤c≤0.1524, 0.6150≤d≤0.6878, and 0.0367≤e≤0.1258;
(a7) when M is Cr, 0.0057≤a≤0.0664, 0.0171≤b≤0.2055, 0.0210≤c≤0.1694, 0.5665≤d≤0.6904, and 0.0169≤e≤0.2117; and
(a8) when M is Ta, 0.0710≤a≤0.0833, 0.2053≤b≤0.2432, 0.0319≤c≤0.0551, 0.5614≤d≤0.5757, and 0.0410≤e≤0.0881; or
(b) wherein d=0, and e=0 or slightly greater than 0,
(b1) when M is Mo, (b1-1) 0.0548≤a≤0.2173, 0.1367≤b≤0.6469, and 0.1358≤c≤0.7815; or (b1-2) 0.4979≤a≤0.6376, 0.2282≤b≤0.3188, and 0.0436≤c≤0.2772;
(b2) when M is W, (b2-1) 0.1057≤a≤0.2350, 0.3211≤b≤0.7092, and 0.0558≤c≤0.5732; or (b2-2) 0.3295≤a≤0.6485, 0.1573≤b≤0.2966, and 0.0549≤c≤0.5132;
(b3) when M is Sn, (b3-1) 0.1290≤a≤0.1832, 0.4002≤b≤0.5962, and 0.2206≤c≤0.4708; or 0.1990≤a≤0.2420, 0.6566≤b≤0.7194, and 0.0386≤c≤0.1444; or (b3-2) 0.5222≤a≤0.5647, 0.2705≤b≤0.2926, and 0.1427≤c≤0.2073; and
(b4) when M is Si, (b4-1) 0.2080≤a≤0.2157, 0.6500≤b≤0.6895, and 0.0998≤c≤0.1308; or (b4-2) 0.3457≤a≤0.6348, 0.1731b≤0.3318, and 0.0334≤c≤0.4812.

2. The anode catalyst material as claimed in claim 1, being a continuous layer or discontinuous particles loaded on a support.

3. The anode catalyst material as claimed in claim 2, wherein the support comprises metal, carbon material, conductive oxide, conductive nitride, or a combination thereof.

4. The anode catalyst material as claimed in claim 3, wherein the metal comprises titanium, titanium alloy, nickel, nickel alloy, aluminum, aluminum alloy, or a combination thereof.

5. The anode catalyst material as claimed in claim 3, wherein the carbon material comprises graphite, carbon nanotube, carbon fiber, carbon microbead, or a combination thereof.

6. The anode catalyst material as claimed in claim 3, wherein the support includes mesh-shape, foam-shape, porous-shape, or a combination thereof.

7. A water electrolysis device for hydrogen evolution, comprising:
an anode and a cathode disposed in an alkaline aqueous solution,
wherein the anode includes an anode catalyst material having a chemical formula of FeₐNi_{b}M_{c}N_{d}Oₑ,
wherein M is Mo, W, Sn, Si, Nb, V, Cr, Ta or a combination thereof, a+b+c+d+e=1, a>0, b>0, c>0, d≥0, and e≥0,
(a) wherein d>0 and e>0,
(a1) when M is Mo, 0.0121≤a≤0.0753, 0.0366≤b≤0.2257, 0.0544≤c≤0.2917, 0.5059≤d≤0.5925, and 0.0521≤e≤0.1537;
(a2) when M is W, 0.0138≤a≤0.0887, 0.0417≤b≤0.2566, 0.0365≤c≤0.3708, 0.5035≤d≤0.5782, and 0.0403≤e≤0.0778;
(a3) when M is Sn, 0.0458≤a≤0.0836, 0.1307≤b≤0.2519, 0.0440≤c≤0.1979, 0.5335≤d≤0.5853, and 0.035≤e≤0.0920;
(a4) when M is Si, 0.0699≤a≤0.0951, 0.2489≤b≤0.2824, 0.0136≤c≤0.0712, 0.5820≤d≤0.5983, and 0.0106≤e≤0.0280;
(a5) when M is Nb, 0.0590≤a≤0.1057, 0.2089≤b≤0.3227, 0.0052≤c≤0.1257, 0.4804≤d≤0.5454, and 0.0314≤e≤0.1046;
(a6) when M is V, 0.0082≤a≤0.0809, 0.0277≤b≤0.2485, 0.0092≤c≤0.1524, 0.6150≤d≤0.6878, and 0.0367≤e≤0.1258;
(a7) when M is Cr, 0.0057≤a≤0.0664, 0.0171≤b≤0.2055, 0.0210≤c≤0.1694, 0.5665≤d≤0.6904, and 0.0169≤e≤0.2117; and
(a8) when M is Ta, 0.0710≤a≤0.0833, 0.2053≤b≤0.2432, 0.0319≤c≤0.0551, 0.5614≤d≤0.5757, and 0.0410≤e≤0.0881; or
(b) wherein d=0, and e=0 or slightly greater than 0,
(b1) when M is Mo, (b1-1) 0.0548≤a≤0.2173, 0.1367≤b≤0.6469, and 0.1358≤c≤0.7815; or (b1-2) 0.4979≤a≤0.6376, 0.2282≤b≤0.3188, and 0.0436≤c≤0.2772;
(b2) when M is W, (b2-1) 0.1057≤a≤0.2350, 0.3211≤b≤0.7092, and 0.0558≤c≤0.5732; or (b2-2) 0.3295≤a≤0.6485, 0.1573≤b≤0.2966, and 0.0549≤c≤0.5132;
(b3) when M is Sn, (b3-1) 0.1290≤a≤0.1832, 0.4002≤b≤0.5962, and 0.2206≤c≤0.4708; or 0.1990≤a≤0.2420, 0.6566≤b≤0.7194, and 0.0386≤c≤0.1444; or (b3-2) 0.5222≤a≤0.5647, 0.2705≤b≤0.2926, and 0.1427≤c≤0.2073; and
(b4) when M is Si, (b4-1) 0.2080≤a≤0.2157, 0.6500≤b≤0.6895, and 0.0998≤c≤0.1308; or (b4-2) 0.3457≤a≤0.6348, 0.1731b≤0.3318, and 0.0334≤c≤0.4812.

8. The water electrolysis device for hydrogen evolution as claimed in claim 7, wherein the alkaline aqueous solution has a pH of greater than 12 and less than or equal to 15.
